(19) United States
(12) Patent Application Publication
(10) Pub. No.: US 2004/0093187 A1
(43) Pub. Date: May 13, 2004

(54) Multiple tag interrogation system

(76) Inventors: Andrew N Dames, Cambridge (GB); James MC England, Cambridge (GB); Andrew RL Howe, Essex (GB)

Correspondence Address: NIXON & VANDERHYE, PC, 1100 N GLEBE ROAD, 8TH FLOOR, ARLINGTON, VA, 22201-4714, US

(21) Appl. No.: 10/333,466

(22) PCT Filed: Jul. 20, 2001
(86) PCT No.: PCT/GB01/03277

(30) Foreign Application Priority Data
Jul. 21, 2000 (GB) 0017882.2

(51) Int. Cl. G06K 7/08

(52) U.S. Cl. 702/188

(57) ABSTRACT

There is described a multiple tag interrogation system (10) for simultaneously interrogating a plurality of tags (200, 210, 220) each including at least two interrogatable features (600, 610, 620) the system (10) comprising a receiving region (50) for receiving the tags (200, 210, 220), interrogating means (100, 110, 150, 160, 170) for interrogating the tags (200, 210, 220) and processing means (40) to determine at least information carried by the said at least two interrogatable features (600, 610, 620) of each tag and spatial position characteristics of the said at least two interrogatable features (600, 610, 620) therein and to identify the information carried by individual tags (200, 210 220) on the basis of the spatial characteristics of the interrogatable features (600, 610, 620). The invention also includes the method of multiple tag interrogation.

The present invention relates to a multiple tag interrogation system, namely a tag interrogation system capable of simultaneously interrogating a plurality of tags. The invention also relates to a method of processing signals received in the system from the tags to resolve their individual identities.

### BACKGROUND TO THE INVENTION

Tags are compact devices, for example in the order of a few mm's to a few cm's in size, which can be affixed to carriers, for example objects and animals. Such tags enable spatial positions of their carriers to be monitored and/or identities of the carriers to be determined. Moreover, tags have already found use in diverse fields, for example in retailing, in livestock monitoring and in personnel security systems.

Systems for interrogating tags are also known. For example, in a published international PCT patent application PCT/GB99/00081, there is described a tag reading system for interrogating a magnetic data tag. The tag comprises a stack of magnetic layers assembled together. Each layer has associated therewith a corresponding easy axis; the layer is most susceptible to being magnetised when a magnetising field is applied to the layer along its easy axis. In order to render the tag encoded with data, the layers in the stack are orientated so that their respective easy axes lie along mutually different directions. In operation, the reading system is capable of determining angular orientations of the easy axes of the layers and thereby is capable of reading the data from the tag.

The reading system described above experiences difficulty when a plurality of magnetic tags are placed simultaneously within its interrogation field. Although the system is capable of determining angular orientations of layers included within its interrogation field, the system is not capable of associating particular layers with particular tags. For example, when the system is presented with thirty magnetic tags in its interrogation field, each tag comprising eight layers, the system will measure two hundred and forty layer angular orientations but will be unable to correlate these orientations with their corresponding tags. Such a lack of correlation represents a problem which the invention seeks to address.

### SUMMARY OF THE INVENTION

According to a first aspect of the present invention, there is provided A multiple tag interrogation system for simultaneously interrogating a plurality of tags each including at least two interrogatable features, the system comprising a receiving region for receiving the tags interrogating means for interrogating the tags and processing means to determine at least information carried by the said at least two interrogatable features of each tag and spatial position characteristics of the said at least two interrogatable features therein and to identify the information carried by individual tags on the basis of the spatial characteristics of the interrogatable features.

The invention is of advantage in that it not only is capable of determining spatial positions of the tags but also their angular orientations and hence their identities.

Identification tags are preferably interrogated using electromagnetic fields which are non-hazardous in use. Preferably, the interrogating means is operable to interrogate the tags by using one or more of steered magnetic fields, ultrasonic radiation and electromagnetic radio radiation. Steered magnetic fields are especially preferable for interrogating tags because they can be readily generated and do not suffer multipath problems associated with high frequency radiation such as microwave radiation. Such a lack of multipath effects makes tag interrogation more reliable.

Preferably, the interrogating means includes transmitting means for directing an interrogating field towards the tags and receiving means for receiving a return field output from the tags in response to receiving the interrogating field thereat.

More preferably, the receiving means is arranged to be substantially insensitive to the interrogating field directed towards the tags and sensitive to the return field output from the tags. Rendering the receiving means substantially insensitive to the interrogating field enables the receiving means to receive a relatively weak return field generated at the tags without being swamped by the interrogating field, thereby easing signal processing requirements associated with identifying the tags.

In order to render the receiving means substantially insensitive to the interrogating field, the receiving means preferably comprises at least one sensor comprising a pair of transducers responsive to the interrogating field and to the return field, the transducers being arranged in opposition to render the pair substantially insensitive to the interrogating field and sensitive to the return field. Thus, the transducers are preferably operable to generate equal and opposing signals in response to the interrogating field and yet provide a mutually differential response to the return field.

Preferably, the receiving means includes a plurality of sensors disposed around the region, and processing means for processing signals generated from the sensors in response to receiving the return field thereat, the processing means being operable to determine relative amplitude of the signals and thereby calculate spatial distribution of the tags within the region.

When a relatively large number of tags are simultaneously inserted into the region to be interrogated by the system, uncertainty in the return field from the tags can arise. Such uncertainty arises from a number of causes such as system noise. In order to reduce such uncertainty, the interrogating means preferably includes field modifying means for applying a quasi-static field gradient within the region for reducing ambiguity when identifying the tags. Including the field gradient is of advantage in that it is capable of providing a wider range of information in the return field for use in mutually distinguishing the tags.

Likewise, the system preferably includes transporting means for conveying the tags through the region to assist the system with identifying the tags. Again, altering the spatial positions of the tags potentially provides more information in the return field which can be used to resolve ambiguity when identifying the tags.

However, in some situations, the tags can abut and are thereby intrinsically ambiguous. The inventors have appreciated that such ambiguity can be addressed by spatially redistributing the tags within the region. Thus, the transporting means preferably includes distributing means for spatially redistributing the tags as they are transported through the region, the system being operable to interrogate the tags before and after the spatial redistribution. The possibility of two tags remaining ambiguously juxtaposed both before and after redistribution is relatively small.

Preferably, the transporting means comprises a conveyor belt associated with the region for transporting the tags therethrough. Such a conveyor belt is especially practical when the system is employed in retailing applications, for example at payment stations in supermarkets.

Preferably, the system includes controlling means for transporting the tags in at least one of a continuous manner and stepwise manner through the region. Continuous transportation of the tags through the region is of advantage when tag identification relies on sampling the return data for a sequence of tag positions. Conversely, stepwise motion of the conveyor belt is advantageous when the processing means requires time to perform computation to identify the tags in circumstances where it is undesirable to move the tags from the interrogation region until the tags have been identified.

Preferably, the transmitting means includes one of more transducers arranged to steer an interrogating field within the region for measuring angular orientation of the tags within the region. Such field steering is of advantage when the tags include structures which are responsive to angular directions in which they are interrogated.

When measuring the aforesaid structures, the system preferably includes means for measuring spatial position and angular orientation of features of the tags within the region, the system further comprising computing means for grouping the features into clusters and thereby identifying from the clusters identity of the tags included within the region. Such identification of clusters is beneficial when the tags include a plurality of structures which individually respond to interrogating field directed theretowards.

When a large number of tags are included in the region simultaneously for interrogation, data processing demands on the system can be significant, the system performing numerous computations to identify the tags present. In order to reduce the data processing demands, it is preferable that the computing means is arranged to discard data supplied from the interrogating means when performing computations corresponding to one or more tags which have already been identified in the region.

The inventors have found that the system is especially appropriate for use with magnetic identification tags. Thus, the system is preferably operable to interrogate magnetic tags.

According to a second aspect of the present invention, there is provided a method for simultaneously interrogating a plurality of tags each including at least two interrogatable features, the method comprising passing the tags through an interrogation region, interrogating the tags in the interrogation region determining from the interrogation information carried by the said at least two interrogatable features of each tag, determining spatial position characteristics of the said at least two interrogatable features and identifying the information carried by individual tags on the basis of the spatial characteristics of the interrogatable features.

Preferably the method includes the steps of:

(a) receiving signals generated in the tags in response to interrogation thereof;

(b) identifying spatial position and angular orientation of features of the tags.

(c) grouping the features into clusters based upon their spatial positions and thereby determining corresponding tags to which they belong; and

(d) determining from the angular orientation of the features within each cluster data encoded into their associated tag, thereby identifying their associated tag.

Preferably, the method further comprising the step of associating characteristics in the signals with operating parameters of the system and spatial positions of the tags, and solving a plurality of simultaneous equations for calculating angular orientations of features included within the tags and determining from the orientations data encoded on the tags.

It will be appreciated that any one or more of the preferred features described in the foregoing can be combined in any combination without departing from the scope of the invention.

### DESCRIPTION OF THE DRAWINGS

Embodiments of the invention will now be described, by way of example only, with reference to the drawings in which:

FIG. 1 is a schematic diagram of a multiple tag interrogation system according to the invention;

FIG. 2 is a schematic diagram of the system of FIG. 1 in more detail;

FIG. 3 is a schematic diagram illustrating clustering within an interrogation region of the system of FIG. 1;

FIG. 4 is a schematic diagram of excitation coils included within the system in FIG. 1;

FIG. 5 is a view of vectorial summing of magnetic fields generated by the excitation coils of FIG. 4;

FIG. 6 is an illustration of instantaneous steering direction of a resultant magnetic field generated within the system in FIG. 1 for interrogating tags within the interrogation region;

FIG. 7 is a schematic diagram of pickup coil pairs included within the system in FIG. 1;

FIG. 8 is a view of one of the pickup coil pairs of FIG. 7, the pair comprising two concentrically-mounted pickup coils;

FIG. 9 is a diagram of a magnetic tag for use with the system in FIG. 1;

FIG. 10 is a diagram of a resultant interrogating magnetic field H_{f} relative to two layers of the tag in FIG. 9; and

FIG. 11 is a diagram of the two layers in FIG. 10 flipping their magnetic state in response to being interrogated by the resultant magnetic field H_{f}.

### DESCRIPTION OF EMBODIMENTS OF THE INVENTION

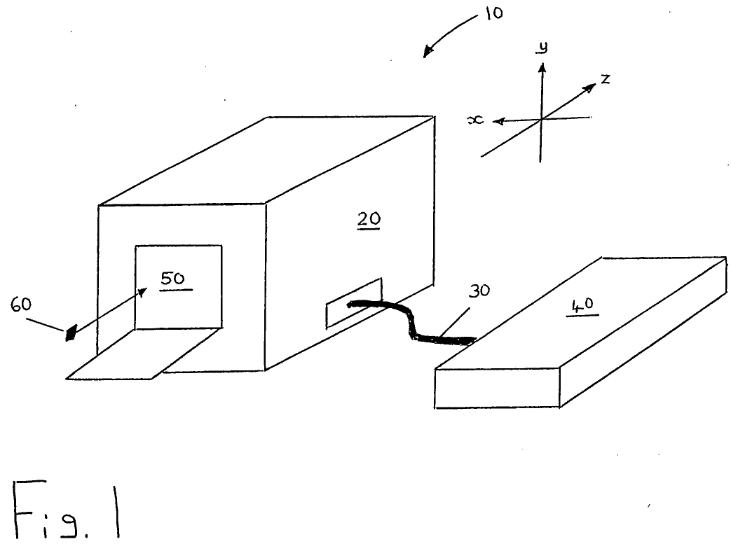

Referring to FIG. 1, there is shown a multiple tag interrogation system indicated generally by 10. The system 10 comprises a reader unit 20 connected via a bundle of cables 30 to an associated signal processing unit 40. The reader unit 20 includes an interrogation region 50 for accommodating one or more tags to be interrogated, for example a tag 60.

If required, the reader unit 20 further comprises a conveyor belt (not shown) for conveying articles with tags affixed thereto through the interrogation region 50. In operation, the belt can transport the articles in a continuous motion or in a stepwise motion. Alternatively, a chute can be used instead of, or in addition to, the conveyor belt. Moreover, if required, a fluid can be used to assist with transporting the articles, for example water jets and/or air jets.

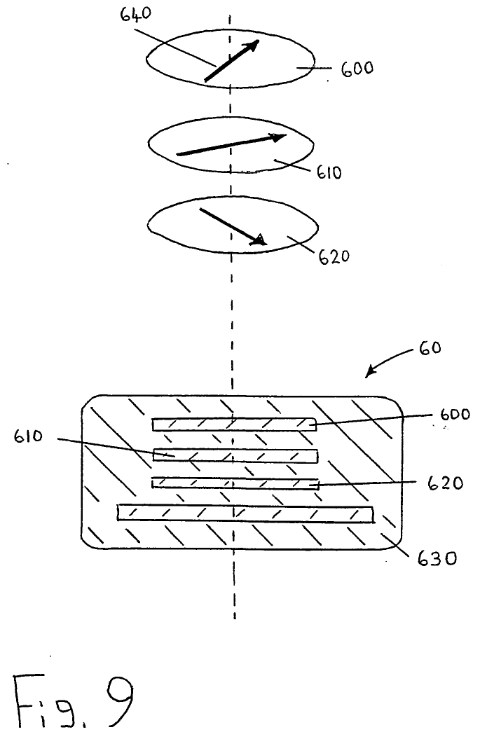

The tag 60 comprises a stack of magnetic layers assembled together, for example as illustrated in FIG. 9. Each layer has associated therewith a corresponding easy axis; the layer is most susceptible to being magnetised when a magnetising field is applied to the layer along its easy axis. In order to render the tag 60 encoded with data, the layers in the stack are orientated so that their respective easy axes lie along mutually different directions.

Operation of the system 10 will now be described in overview. Power is applied to the processing unit 40 which generates interrogation signals. The interrogation signals are conveyed through the bundle of cables 30 to the reader unit 20. At the reader unit 20, the interrogation signals cause a corresponding resultant interrogation magnetic field to be generated within the interrogation region 50. The tag 60 is then inserted into the region 50 and is exposed therein to the interrogation field. On account of magnetic hysteresis characteristics of the layers of the tag 60, the tag 60 couples at least some of the interrogation field into a corresponding response magnetic field which is sensed within the reader unit 20 to generate corresponding pickup signals. The pickup signals are amplified and then conveyed through the bundle of cables 30 to the processing unit for processing. By processing the amplified pickup signals, the processing unit 40 determines relative orientations of the layers of the tag 60 and also a spatial position of the tag 60 within the interrogation region 50.

On account of the system 10 determining spatial position of the layers of the tag 60 in addition to their relative angular orientations, the system 10 is capable of simultaneously interrogating a plurality of tags, for example similar to the tag 60, inserted into the interrogation region 50.

It will be appreciated that the system 10 is illustrated as being a compact system for indoor use. The system 10 can be adapted, without departing from the scope of the invention, for supporting larger interrogation regions; for example, the region 50 can correspond to a factory area or even a row of buildings.

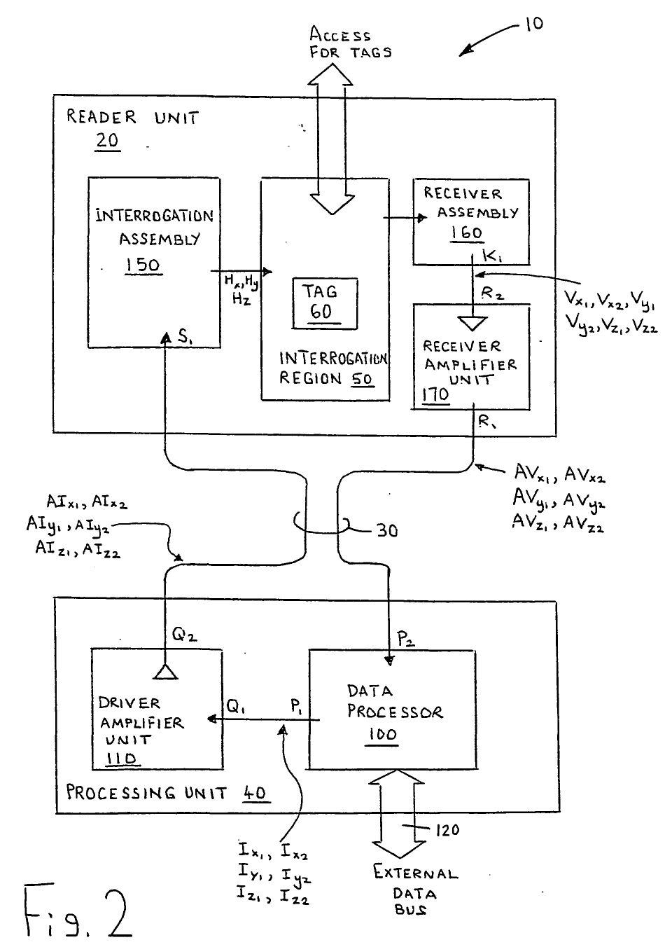

Referring next to FIG. 2, there is shown the system 10 in more detail. The processing unit 40 includes a data processor 100 and a driver amplifier unit 110. The processor 100 is coupled at its output port P₁ to a corresponding input port Q₁ of the driver unit 110. The data processor 100 comprises an external data bus 120 for communicating identified tag information to external devices (not shown), for example to a data management system responsible for stock control of manufactured items identifiable by tags affixed thereto.

The reader unit 20 comprises an interrogation assembly 150, the aforesaid interrogation region 50, a receiver assembly 160 and a receiver amplifier unit 170. The interrogation assembly 150 is connected at its input port S₁ via the bundle of cables 30 to an output port Q₂ of the driver amplifier unit 110. Moreover, the receiver assembly 160 is coupled at its output port K₁ to an input port R₂ of the receiver amplifier unit 170. Furthermore, the receiver amplifier unit 170 is coupled from its output port R₁ via the bundle of cables to an input port P₂ of the data processor 100.

The interrogation assembly 150 comprises three sets of excitation coils, namely an x-axis set, a y-axis set and a z-axis set. The x-axis, y-axis and z-axis are mutually orthogonal Cartesian axes. Moreover, each set of excitation coils includes first and second excitation coils disposed on mutually opposing faces of the interrogation region 50. The excitation coils will be described in further detail later. Each excitation coil has associated therewith a driver amplifier in the driver unit 110, the driver amplifier not only capable of driving its associated excitation coil with an alternating current component by also with a substantially constant current component for generating a field gradient within the interrogation region 50.

Similarly, the receiver assembly 160 comprises first and second pickup coil arrangements.

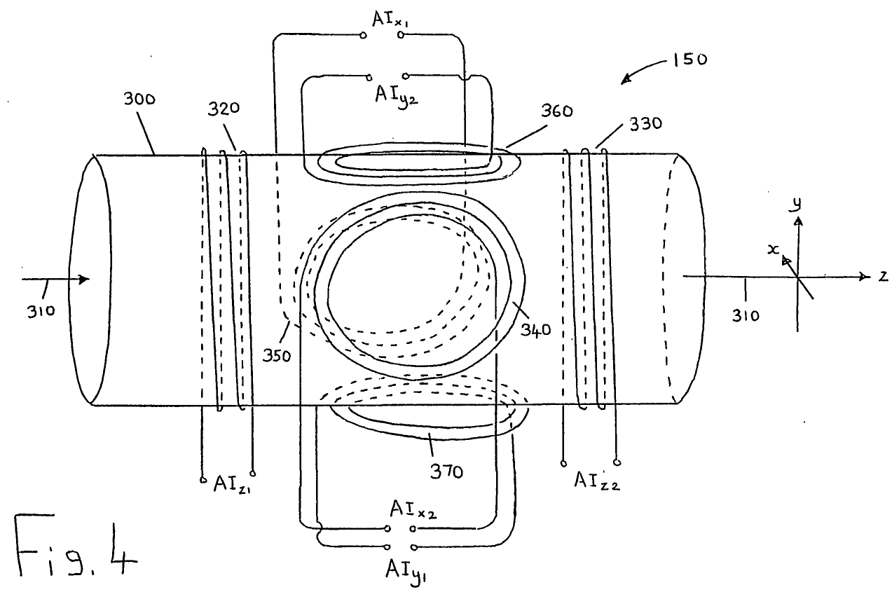

The first arrangement comprises three sets of pickup coils, namely an x-axis set, a y-axis set and a z-axis set; the x-axis, y-axis and z-axis for the pickup coils correspond to the Cartesian axes of the aforesaid excitation coils. Each set of pickup coils comprises first and second coil pairs, the first and second pairs being positioned on opposing faces of the interrogation region 50 as illustrated in FIG. 4. Each pickup coil pair comprises first and second pickup coils mounted mutually concentrically with their principal magnetic axes disposed co-linearly.

Each pair of pickup coils in the first arrangement in the receiver assembly 160 has its pickup coils connected in series, each pair being coupled to an associated receiver amplifier in the receiver amplifier unit 170. Moreover, each pair of pickup coils has its pickup coils fabricated with similar turns area so that the pair is sensitive to magnetic fields generated in close proximity thereto and substantially insensitive to magnetic fields generated remotely therefrom, for example to magnetic fields generated by the excitation coils and remote interfering magnetic fields penetrating into the reader unit 20. Thus, for example, the pairs of pickup coils are substantially sensitive only to coupled magnetic fields Hₙ arising from non-linear magnetic processes occurring within the tag 60 when placed in the interrogation region 50. If required, the reader unit 20 is preferably provided with exterior magnetic shielding, for example with high relative permeability mu-metal shielding.

The second pickup coil arrangement comprises an orthogonal set of six gradient receiver coils. As will be described later, the additional set of gradient coils enables the system to determine readily the orientation and position of tag layers within the interrogation region 50. Preferably one or more of the coils of the second arrangement are quadrapole coils. If required, more than six gradient receiver coils can be provided.

However, when more than six gradient coils are provided, at least some of them will be mounted within the system 10 at mutually non-orthogonal orientations.

Operation of the system 10 will now be described in more detail with reference to FIG. 2. The data processor 100 generates six interrogation signals Iₓ₁, Iₓ₂, I_{y1}, I_{y2}, I_{z1}, I_{z2}.

These signals are output to the driver amplifier unit 110 which amplifies them to generate corresponding amplified output signals Alₓ₁, Alₓ₂, Al_{y1}, Al_{y2}, Al_{z1}, Al_{z2} respectively. The amplified output signals Alₓ₁, Alₓ₂, Al_{y1}, Al_{y2}, Al_{z1}, Al_{z2} are applied to the excitation coils associated therewith; thus, the output signals Alₓ₁, Alₓ₂ are applied to the x-axis excitation coils, the output signals Al_{y1}, Al_{y2} are applied to the y-axis excitation coils, and the output signals Al_{z1}, Al_{z2} are applied to the z-axis excitation coils. The amplified output signals result in corresponding magnetizing currents to flow through their respective excitation coils. These magnetizing currents result in each of the sets generating a corresponding magnetizing field in the interrogation region 50, namely the x-axis, y-axis and z-axis excitation coils result in generation of an x-axis magnetic field component Hₓ, a y-axis magnetic field component H_{y}, and a z-axis magnetic field component H_{z} respectively. These three components Hₓ, H_{y}, H_{z} penetrate into the interrogation region 50 and vectorially combine to provide an overall resultant interrogation magnetic field H_{f}. By varying the interrogation signals, the data processor 100 is capable of steering the resultant magnetic field H_{f} in any direction within the interrogation region 50. In operation, the data processor 100 steers the resultant field H_{f} in a repetitive 3-dimensional spiral path so that the tag 60 is interrogated by the field H_{f} from all directions. Other steering paths are possible.

When the resultant field H_{f}, when resolved relative to planes of the layers of the tag 60, is of sufficient magnitude to cause non-linear magnetic switching to occur in the layers of the tag 60, the switching associated with the B-H hysteresis characteristics of the tag 60 magnetic coatings, there is generated a magnetic field Hₙ at the tag 60 which is received by the receiver assembly 160. Depending upon distances and orientations of the pairs of pickup coils of the receiver assembly 160 relative to the tag 60, the pickup coils generate corresponding pickup signals which are conveyed to the receiver amplifier unit 170 which amplifies the pickup signals to generate corresponding amplified pickup signals. The relative amplitudes of pulsed signal components in the amplified pickup signals, the pulsed components resulting from the non-linear magnetic switching characteristics of the tag 60 layers, are indicative of the spatial position of the layers of the tag 60 within the interrogation region 50 relative to the receiver assembly 160.

Moreover, the time of occurrence of the pulsed signal components and their magnitude relative to the steered direction of the resultant field H_{f} is used by the data processor 100 the calculate relative angular orientations of the easy axes of the layers of the tag 60.

Thus, when a plurality of tags similar to the tag 60 are simultaneously inserted into the interrogation region 50, the data processor 100 is capable of interrogating the tags and determining spatial positions of their layers and their relative angular orientations.

When determining spatial positions of the layers of the tags, the data processor 100 applies an algorithm to associate layers which have substantially similar spatial locations and deduce thereby that they are layers of a corresponding tag; such an algorithm is known as a clustering algorithm.

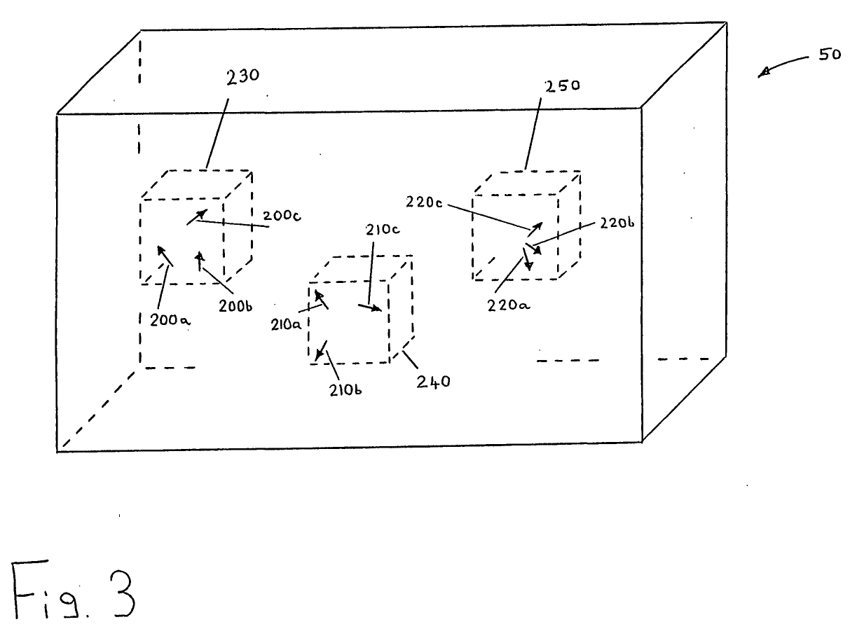

In FIG. 3, there is shown the interrogation region 50 including nine magnetic layers 200a, 200b, 200c, 210a, 210b, 210c, 220a, 220b, 220c susceptible to being detected by the system 10. The system 10 is capable of determining the angular orientation of each of these layers and their spatial positions within the interrogation region 50. The data processor 100 then applies the clustering algorithm which effectively sweeps a number of test volumes, for example test volumes 230, 240, 250, through the interrogation region 50. When the data processor 100 identifies that the test volumes include a number of the layers, for example three layers as illustrated, and spatial borders devoid of tags exist around the test volumes, the data processor 100 identifies the volumes as corresponding to tags. Thus, in FIG. 3, the data processor 100 identifies that there are three tags in the interrogation region 50, each tag comprising a stack of three layers; the three tags include a first tag in the volume 230 comprising the layers 200a, 200b, 200c, a second tag in the volume 240 comprising the layers 210a, 210b, 210c, and a third tag in the volume 250 comprising the layers 220a, 220b, 220c. In FIG. 3, easy axes directions associated with the layers are shown represented by arrows on the layers 200, 210, 220

It will be appreciated from FIG. 3 that misidentification of the tags can occur if the test volumes 230, 240, 250 are made too small. Moreover, misidentification can also arise if the volumes 230, 240, 250 and/or their associated spatial borders are made too large.

The system 10 can be arranged to raise an alarm when misidentification of tags occurs so that ambiguities can be resolved manually. Alternatively, the alarm can be used to trigger spatial redistribution of tags within the region 50; for example, the conveyor belt can be actuated to cause the tags to tumble and thereby become spatially redistributed within the region 50.

When a plurality of tags are placed within the interrogation region 50, there can arise situations where two or more tags are in close proximity. In such situations, ambiguity arises and the system 10 is potentially susceptible to incorrectly associating layers together into tag layer groupings or even failing to identify the presence of a tag in the interrogation region 50. The inventors have appreciated that such ambiguity can potentially arise and have therefore provided the system 10 with additional features for addressing such ambiguity.

For example, the reader unit 20 includes a conveyor belt for conveying a plurality of tags in a linear trajectory through the interrogation region 50. As new tags enter into the interrogation region 50 and are subjected to the interrogation field H_{f}, new corresponding signal peaks simultaneously arise in the amplified receiver signals provided from the receiver amplifier unit 170 to the data processor 100. Likewise, when old tags are swept out of the interrogation region 50, their corresponding peaks simultaneously disappear from the signals provided from the receiver unit 170 to the processor 100.

Thus, by monitoring the simultaneous occurrence and subsequent disappearance of peaks in the amplified receiver signals from the receiver unit 170, the data processor 100 is capable of resolving ambiguities when clustering data indicative of the position and orientation of tag layers within the interrogation region 50.

The system 10 also incorporates other features to assist with correctly clustering tag layers together within the data processor 100. For example, each driver amplifier included within the driver unit 110 is connected to its associated excitation coil in the interrogation assembly 150, the excitation coils thereby being differentially drivable.

Moreover, as described in the foregoing, each driver amplifier is capable of supplying magnetising current Al to its associated excitation coil, the current comprising a more slowly varying quasi-static offset current and a more rapidly temporally changing steering component associated with steering the resultant magnetic field H_{f} within the interrogation region 50. The quasi-static offset current can be used by the system 10 to establish a corresponding magnetic field gradient within the interrogation region 50 by employing mutual different magnitudes of offset current in mutually opposite excitation coils. Such a magnetic field gradient can be measured within the interrogation region 50 during calibration of the system 10. As tags enter the interrogation region 50, they respond with peaks associated with their magnetic field Hₙ differently depending upon in which region of the magnetic field gradient they are located. Thus, by one or more of conveying the tags through the interrogation region 50 on the conveyor belt and taking a number of signal peak measurements for different magnetic field gradients established within the region 50, for example by changing the quasi-static field gradient in a slow stepwise manner, additional information can be provided to the data processor 100 for assisting it to cluster layers correctly when situations of potential ambiguity arise.

Ambiguities in clustering can arise where a plurality of objects with magnetic tags affixed thereto are included simultaneously within the interrogation region 50. The items can, for example, result in distortion of the magnetic field H_{f} and upset spatial position measurement depending upon the relative amplitude of signal peaks in the pickup signals generated in response to the magnetic field Hₙ. Moreover, the items can potentially abut on the aforesaid conveyor belt so that they are spatially adjacent to one another. There will thereby arise situations where it is fundamentally impossible to resolve tags although, by using the conveyor belt with associated multiple sampling and magnetic field gradient approaches as described above, it is possible to greatly reduce the occurrence of such ambiguous situations.

In order to further describe operation of the system 10 and its ability to resolve multiple tags in the interrogation region 50, FIG. 4 will now be elucidated. In FIG. 4, there is shown a deployment of the excitation coils of the interrogation assembly 150 around the interrogation region 50. The interrogation region 50 is implemented in the system 10 in the form of a tunnel 300 through which articles bearing associated magnetic tags are conveyed in a direction indicated by arrows 310, namely from left to right parallel to a z-axis as shown. The tunnel 300 can be relatively large, for example it can have a nominal diameter in a range of 25 cm to 35 cm and a length in a range of 30 cm to 50 cm. In order to be compatible with the tunnel 300, the excitation coils are preferably substantially round ring-like coils having a nominal diameter substantially similar to that of the tunnel 300, for example the diameter is preferably in a range of 25 cm to 35 cm.

The six excitation coils comprise first and second z-axis excitation coils 320, 330 associated with establishing the magnetic field H_{z} in the z-axis direction; the coils 320, 330 are deployed on mutually opposite faces of the interrogation region 50 with their magnetic axis disposed co-linearly along the z-axis. In operation, the first and second z-axis coils 320, 330 are driven by the driver signals Al_{z1}, Al_{z2} respectively provided from the driver unit 110.

The six excitation coils further comprise first and second x-axis excitation coils 340, 350 associated with establishing the magnetic field Hₓ in an x-axis direction as shown in FIG. 4. The coils 340, 350 are deployed on mutually opposite faces of the interrogation region 50 with their magnetic axes disposed co-lineally along the x-axis. In operation, the first and second x-axis coils 340, 350 are driven by the driver signals Alₓ₁, Alₓ₂ respectively provided from the driver unit 110.

The six excitation coils further comprise first and second y-axis excitation coils 360, 370 associated with establishing the magnetic field H_{y} in a y-axis direction as shown in FIG. 4. The coils 360, 370 are deployed on mutually opposite faces of the interrogation region 50 with their magnetic axes disposed co-lineally along the y-axis. The first and second y-axis coils 360, 370 are driven in operation by the driver signals Al_{y1}, Al_{y2} respectively provided from the driver unit 110.

The excitation coils 320 to 370 are deployed in a Helmholtz-type configuration to generate more uniform magnetic field distributions within the interrogation region 50. However, as described in the foregoing, the system 10 is designed to be capable of establishing magnetic field gradients in the region 50 to assist with distinguishing between tags inserted therein.

In FIG. 4, the x-, y-, z-axes are mutually orthogonal and define Cartesian axes of the system 10.

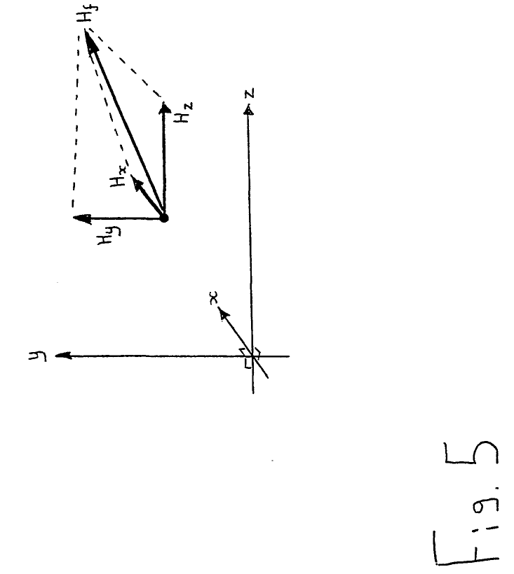

In FIG. 5, there is an illustration of vectorial summation of the magnetic fields Hₓ, H_{y}, H_{z} to generate the resultant magnetic field H_{f}. By varying the amplified drive signals Al to the excitation coils, the magnitudes of Hₓ, H_{y}, H_{z} can be varied and hence the magnitude and steering direction of the resultant magnetic field H_{f} varied.

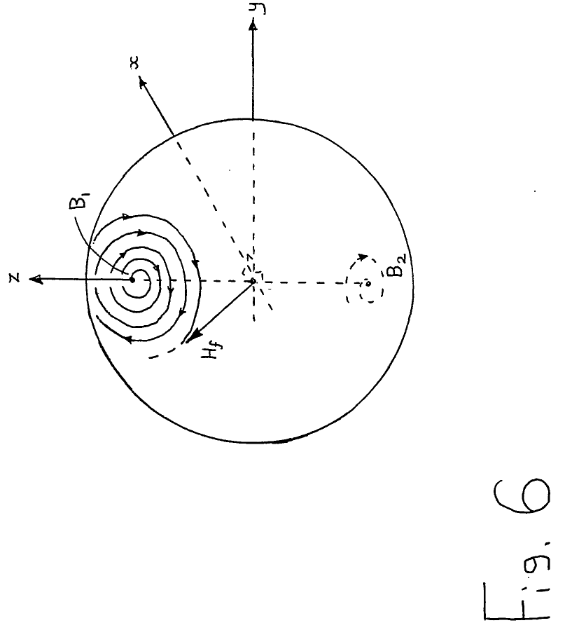

The data processor 100 changes the drive signals output therefrom to the driver unit 110 to steer the resultant magnetic field H_{f} in a spiral manner in 3-dimensions as illustrated in FIG. 6. Thus, the field H_{f} is swept through all angles in the interrogation region 50 from a start position B₁ to a finish position B₂. The data processor 100 is operable to sweep the field H_{f} repeatedly in the spiral path in a cyclical repetitive manner at a frequency in the order of 150 Hz. It will appreciated that although a spiral manner of resultant field H_{f} steering is described, other manners of steering can alternatively be employed if required, for example to enable the system 10 to disregard tags whose layers are orientated in certain directions within the interrogation region 50.

In order to described operation of the system 10, the receiver assembly 160 will now be described in further detail after which generation of signal peaks from the tags within the interrogation region 50 will be elucidated. Lastly, data processing performed within the data processor 100 will be described.

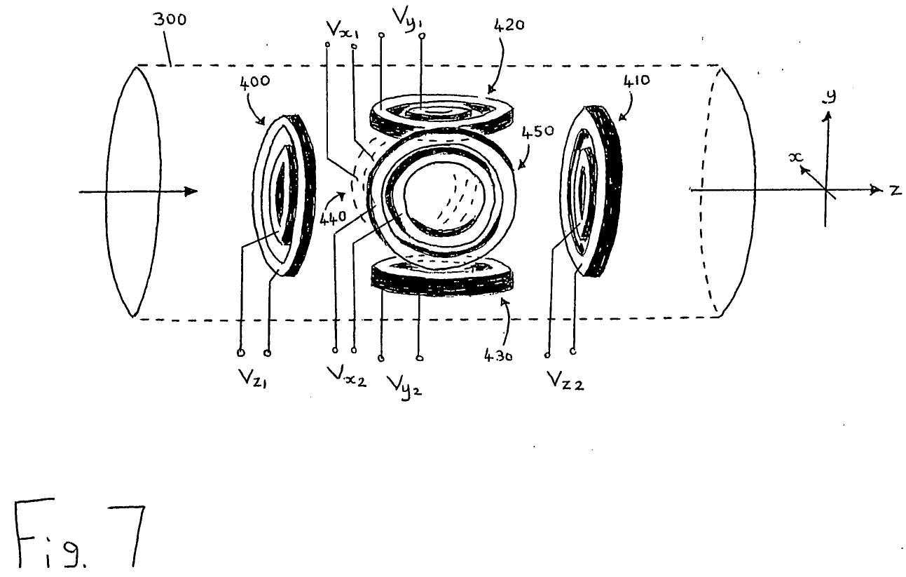

Referring to FIG. 7, there is shown pickup coil pairs of the first arrangement of the receiver assembly 160. These pickup coil pairs are disposed around the interrogation region 50 between the excitation coils 320 to 370 and the region 50, namely the pickup coil pairs are smaller in area and size than the excitation coils. The pickup coil pairs are nominally substantially aligned to the x-, y- and z-axis although this is not essential for operation of the system 10.

The receiver assembly 160 comprises first and second z-axis pickup coil pairs 400, 410 disposed on mutually opposite faces of the interrogation region 50. Pickup coils of the pairs 400, 410 are aligned so that their principal magnetic axes are parallel to the z-axis as shown in FIG. 7. The pickup coils of the first pair 400 are connected in series to provide an output V_{z1}; moreover, the coils of the first pair 400 have similar turns area so that the pair 400 is responsive to magnetic fields generated in close proximity thereto, for example from one or more tags in the region 50, but substantially unresponsive to the magnetic fields, namely Hₓ, H_{y}, H_{z}, generated by the excitation coils 320 to 370.

Likewise, the pickup coils of the second pair 410 are connected in series to provide an output V_{z2}; moreover, the coils of the second pair 410 have similar turns area so that the pair 410 is responsive to magnetic fields generated in close proximity thereto, for example from one or more tags in the region 50, but substantially unresponsive to the interrogating magnetic fields, namely Hₓ, H_{y}, H_{z}, generated by the excitation coils 320 to 370.

Similarly, the receiver assembly 160 comprises first and second y-axis pickup coil pairs 420, 430 disposed on mutually opposite faces of the interrogation region 50. Pickup coils of the pairs 420, 430 are aligned so that their principal magnetic axes are parallel to the y-axis as shown in FIG. 7. The pickup coils of the first pair 420 are connected in series to provide an output V_{y1}; moreover, the coils of the first pair 420 have similar turns area so that the pair 420 is responsive to magnetic fields generated in close proximity thereto, for example from one or more tags in the region 50, but substantially unresponsive to the interrogating magnetic fields, namely Hₓ, H_{y}, H_{z}, generated by the excitation coils 320 to 370. Likewise, the pickup coils of the second pair 430 are connected in series to provide an output V_{y2}; moreover, the coils of the second pair 430 have similar turns area so that the pair 430 is responsive to magnetic fields generated in close proximity thereto, for example from one or more tags in the region 50, but substantially unresponsive to the interrogating magnetic fields, namely Hₓ, H_{y}, H_{z}, generated by the excitation coils 320 to 370.

Similarly, the receiver assembly 160 comprises first and second x-axis pickup coil pairs 440, 450 disposed on mutually opposite faces of the interrogation region 50. Pickup coils of the pairs 440, 450 are aligned so that their principal magnetic axes are parallel to the x-axis as shown in FIG. 7. The pickup coils of the first pair 440 are connected in series to provide an output V_{y1}; moreover, the coils of the first pair 440 have similar turns area so that the pair 440 is responsive to magnetic fields generated in close proximity thereto, for example from one or more tags in the region 50, but substantially unresponsive to the interrogating magnetic fields, namely Hₓ, H_{y}, H_{z}, generated by the excitation coils 320 to 370. Likewise, the pickup coils of the second pair 450 are connected in series to provide an output V_{y2}; moreover, the coils of the second pair 450 have similar turns area so that the pair 450 is responsive to magnetic fields generated in close proximity thereto, for example from one or more tags in the region 50, but substantially unresponsive to the interrogating magnetic fields, namely Hₓ, H_{y}, H_{z}, generated by the excitation coils 320 to 370.

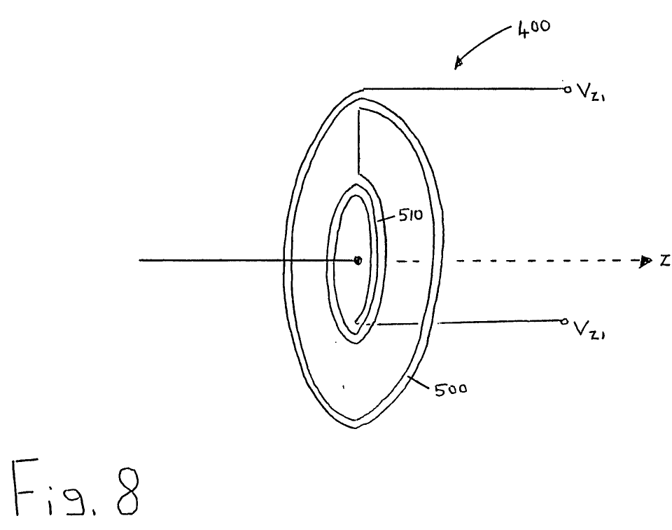

The pairs 400 to 450 are of mutually similar construction. In FIG. 8, the pickup pair 400 is shown schematically in more detail. The pair 400 comprises an outer pickup coil 500 having a nominal radius r, and an inner pickup coil 510 having a nominal radius r₂.

The inner and outer coils are concentrically mounted within the reader unit 20 and their principal magnetic axes are disposed co-lineally as illustrated. The outer coil 500 includes n₁ turns, each turn substantially enclosing an area A₁=πr₁². Likewise, the inner coil 510 includes n₂ turns, each turn substantially enclosing an area A₂=πr₂². The pair 400 is arranged such that:

n₁×A₁=n₂×A₂ Eq. 1

Moreover, the coils 500, 510 are connected in opposition so a remotely generated magnetic field coupling into the coils 500, 510 generates substantially exactly opposing voltages in the coils 500, 510 and hence substantially zero signal. However, a local generated magnetic field, for example the field Hₙ from one or more tags couples differently into the two coils 500, 510 and results in the output signal V_{z1} from the pair 400.

The pickup coils of the second arrangement are preferably constructed in a similar manner to the pickup coils of the first arrangement. Alternatively, the pickup coils of the second arrangement can be single coils rather than opposing coils pairs as in the first arrangement.

Referring to FIG. 9, there is shown the tag 60 in more detail. The tag 60 comprises a stack of three magnetic layers 600, 610, 620 of magnetic material which is susceptible to magnetic saturation at relatively low magnetic field strengths, for example the layers have a coercivity in the order of 5 A/m. It will be appreciated that the tag 60 can, if required, be fabricated to include more than three layers. Each of the three layers has associated therewith an easy axis along which it is most easily magnetised, for example the layer 600 has an easy axis having an orientation as depicted by an arrow 640.

When fabricating the tag 60, the layers 600, 610, 620 are assembled together orientating their easy axes relative to one another to encode onto the tag 60 its associated identification data. After the layers 600, 610, 620 have been assembled into a stack, the stack is encapsulated within a protective plastic material coating to form the tag 60.

Each layer is preferably disc-like with a diameter in the order of 10 mm and comprises a thin film sputtered coat of magnetic material on a PET plastic film substrate. A suitable magnetic material is manufactured by ISF of Zulte, Belgium and marketed under a trade name “Atalante”, namely part number SPR97017A. ISF is owned by its parent company Bekaert. The sputtered coat is preferably in a range of 0.6 μm to 1.5 μm thick, and the plastic film substrate preferably has a thickness in a range of 15 μm to 30 μm.

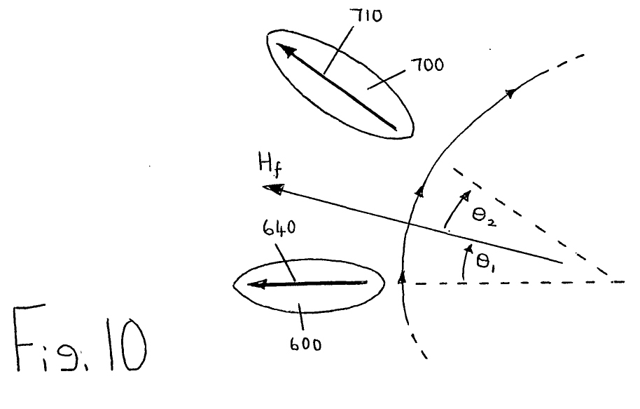

Referring now to FIG. 10, there is shown the resultant magnetic field H_{f} denoted by a vector arrow 650. The magnitude of the resultant field H_{f} is maintained at a sufficient magnitude to overcome magnetic hysteresis in the layers, for example the layer 600 and a layer 700 of another tag in the interrogation region 50. However, if Hₛᵤₛ is a magnetising field strength necessary to cause the layers to flip their magnetic state, the layer 600 will only flip its magnetic state when:

H_{f} cos θ₁>Hₛᵤₛ Eq. 2

where

θ₁ an angle between the easy axis 640 of the layer 600 and the resultant magnetic field vector H_{f} 650.

Likewise, the layer 700 will only flip its magnetic state when:

H_{f} cos θ₂>Hₛᵤₛ Eq. 3

where

θ₂=an angle between the easy axis 710 of the layer 700 and the resultant magnetic field vector H_{f} 650.

It will be appreciated that, when the layers 600, 700 are orientated to be non-parallel and their axes are in mutually different directions, the layers 600, 700 flip magnetic state at different times as the resultant field H_{f} is steered in the interrogation region 50.

Thus, when the resultant field H_{f} is scanned as shown in FIG. 10, the layer 600 will flip magnetic state first followed by the layer 700 as the field H_{f} is steered by the excitation coils 320 to 370 of the interrogation assembly 150 firstly to substantially align with the easy axis 640 and then secondly with the easy axis 710. It will be appreciated from FIG. 6 that the resultant field H_{f} is applied along these easy axes 640, 710 and also counter to these axes to flip the layers 640, 710 around their B-H hysteresis characteristics. Such flipping of hysteresis states is described in detail in the aforementioned international patent application PCT/GB99/00081 which is herewith incorporated by reference. Moreover, such magnetic flipping of hysteresis states gives rise to the magnetic field Hₙ which is detected by the receiver assembly 160.

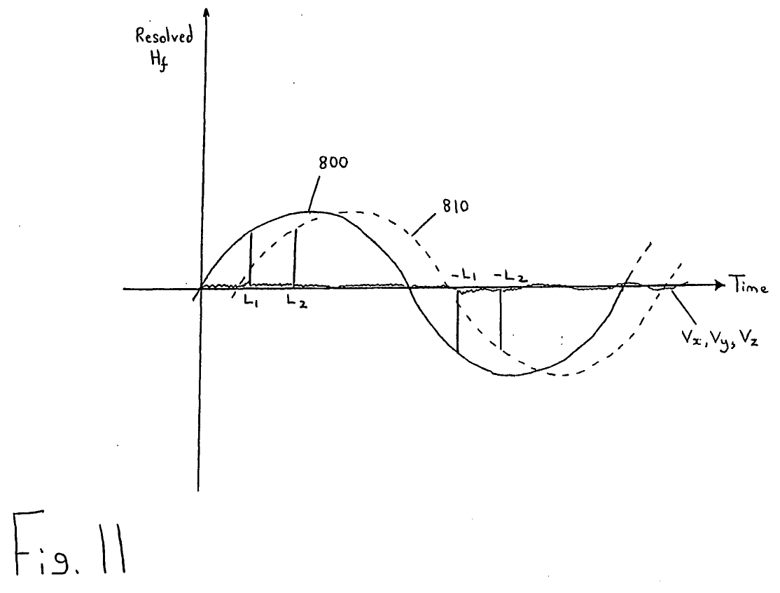

Referring next to FIG. 11, there is shown a graph of the magnetic field component H_{f} resolved with respect to the easy axes of the layers 600, 700 as depicted in curves 800, 810 respectively. It will be appreciated from FIG. 10 that the resultant field H_{f} is aligned to the easy axis 640 before the easy axis 710 which results in corresponding peaks L₁, L₂ in the pickup signals occurring at different time intervals as illustrated in FIG. 11. The data processor 100 is programmed to detect times when the peaks L₁, L₂ occur and use the times in association with the steering direction of the resultant field H_{f} to calculate the angular orientation of the layers 600, 700.

Relative strengths of the pickup signals generated at the coil pairs in the receiver assembly corresponding to the peaks L₁, L₂ are passed to a pulse peak detector in the data processor 100 to establish their peak amplitude and thereby spatial position of the layers 600, 700 within the interrogation region 50. Pickup signal strength reduces in proportion to the reciprocal of the cube of distance; such a relationship is taken into account in software executing in the data processor 100 to determine spatial positions of the tag layers from relative peak amplitudes present in signals from the pickup coils.

When a field gradient is applied to the interrogation region 50 by differentially driving one or more of the excitation coils 320 to 370 with an offset current, the peaks in the pickup signals occur at times which are modified by the direction and magnitude of the field gradient; such modified occurrence times are employed by the data processor 100 to resolve ambiguities in the detection of tags within the interrogation region 50. Additionally, movement of the tags through the interrogation region 50 means that the spatial positions of the tags are temporally changing with respect to the pickup coils, such temporal change is taken into account by the data processor 100 when identifying the tags in the region 50 for resolving tag identification ambiguities.

It will be appreciated from the foregoing that the data processor 100 performs considerable data processing on amplitude data derived from signal peaks arising from magnetic non-linear switching of layers of tags within the region 50. In order to calculate angular orientation of the layers and their spatial positions, the system 10 calculates magnetic vectors associated with the coupled magnetic fields Hₙ.

In the region 50, there are included a plurality of tags, namely n layers in total. An index i is in a range 1 to n for identifying each layer individually. When a non-linear magnetic switching event occurs in the layer i to generate a corresponding coupled field Hₙᵢ. The field Hₙᵢ can be resolved into six variables, namely three dipole vector co-ordinates wₓᵢ, w_{yi}, w_{z1} and three position coordinates xᵢ, yᵢ, zᵢ. Alternatively, it can be resolved into a scalar dipole moment mᵢ, two dipole orientation angles θₐ, θ_{b} and the three position co-ordinates xᵢ, yᵢ, zᵢ. The coupled field H_{f} will not necessarily be aligned to the direction of the resultant field H_{f} because the layer i will flip magnetic state when the interrogation field H_{f} resolved with respect to the easy axis of the layer i is of a sufficient magnitude to cause such a flip as depicted in Equations 2 and 3.

Each flip in magnetic state of the layer i results in corresponding signal peaks akin to L₁, L₂ in FIG. 11 occurring in the pickup signals generated by all the pickup coils of the receiver assembly 160. The magnitude of peaks of the pickup signal of each pickup coil will depend upon the spatial co-ordinates of the layer i relative to the pickup coil and angular orientation of the pickup coil relative to a dipole moment associated with the layer i; the sensitivity of a pickup coil to a dipole moment at a particular orientation in a given spatial position is proportional to a vector dot product between a field vector associated with the dipole and a vector defining the sensitivity of the pickup coil at the spatial position of the dipole. For example, if nine pickup signals are obtained from nine pickup coils disposed around the region 50, the data processor solves nine simultaneous equations to calculate the dipole vector coordinates wₓᵢ, w_{yi}, w_{zi} and the three position coordinates xᵢ, yᵢ, zᵢ. It will be appreciated that more than nine pickup coils can be used and more than nine corresponding pickup signals processed to determine the vector and position co-ordinates.

By appropriate design of pickup coils, simple solution equations for the simultaneous equations can be derived. Thus, using such solution equations, calculation of the dipole vector coordinates wₓᵢ, w_{yi}, w_{zi} and the position coordinates xᵢ, yᵢ, zᵢ is achievable in the data processor 100 merely by, for a given magnetic flip event in the layer i, determining the amplitudes of corresponding peaks in the nine pickup signals and then substituting these amplitudes into the solution equations. Such an approach using solution equations is far preferable to using correlation processes in the data processor 100 for associating signal peaks with corresponding layers, such correlation processes being computationally impractical for large numbers of layers in the region 50.

For example, by employing one or more quadrapole-type pickup coils for the second arrangement in the receiver assembly 160, the pickup coils can be arranged to provide direct measurement of:

E₁=Hₓ; coupled field in the x-axis direction;

E₂=H_{y}; coupled field in the y-axis direction;

E₃=H_{z}; coupled field in the z-axis direction;

E₄=ΔHₓ; gradient of coupled field in the x-axis direction;

E₅=ΔH_{y}; gradient of coupled field in the y-axis direction;

E₆=ΔH_{z}; gradient of coupled field in the z-axis direction;

E₇=H_{yz}; coupled field in the y-axis direction as resolved in z-direction pickup coils;

E₈=H_{xz}; coupled field in the x-axis direction as resolved in z-direction pickup coils; and

E₉=H_{xy}; coupled field in the y-axis direction as resolved in y-direction pickup coils.

Substitution of parameters E₁ to E₉ into Equations 4 to 6 (Eq. 4 to 6) will readily yield position co-ordinates xᵢ, yᵢ, zᵢ:

$$\begin{matrix}{x}_{i} = {k}_{x} [ \frac{2 {E}_{1} {E}_{4} + {E}_{2} {E}_{9} + {E}_{3} {E}_{7}}{2 {E}_{1}^{2} + {E}_{2}^{2} + {E}_{3}^{2}} ] & Eq . 4 \\ {y}_{i} = {k}_{y} [ \frac{2 {E}_{2} {E}_{5} + {E}_{3} {E}_{8} + {E}_{1} {E}_{9}}{{E}_{1}^{2} + 2 {E}_{2}^{2} + {E}_{3}^{2}} ] & Eq . 5 \\ {z}_{i} = {k}_{z} [ \frac{2 {E}_{3} {E}_{6} + {E}_{1} {E}_{7} + {E}_{2} {E}_{8}}{{E}_{1}^{2} + {E}_{2}^{2} + 2 {E}_{3}^{2}} ] & Eq . 6\end{matrix}$$

Preferably, a multivariate clustering algorithm is executed in the data processor 100 to examine the dipole vector coordinates and the position coordinates in the region 50 for multiple cycles of scanning of the interrogation field H_{f}. Such multivariate clustering is desirable for coping with noise in the vector coordinates and position coordinates. If required, averaging can be applied to the dipole vector coordinates and the position coordinates for multiple scan cycles to reduce noise. Moreover, the data processor 100 also preferably executes an checking algorithm to identify overlapping signal peaks arising from two or more layers flipping magnetic state simultaneously in response to the interrogation field H_{f}; when such overlap occurs, the checking algorithm either disregards the peaks or raises an alarm The checking algorithm is operable to test for uniform phase between corresponding simultaneous signal peaks in the pickup signals.

Times at which signal peaks occur in the pickup signals with regard to steering the interrogation field H_{f} enables the magnitude of the field H_{f} with respect to dipole moments of the layers to be resolved and thereby coercivity parameters to be calculated in the data processor 100 for each of the layers; prior calibration of field characteristics of the excitation and pickup coils within the interrogation region 50 is beneficial when calculating such coercivity. In addition to using relative angular orientations of the layers to impart data to the tags, relative coercivity differences between the layers is another approach to impart data to the tags. The pickup coils of the second arrangement can be used to determine the field H_{f} at each layer and thereby enables the coercivity of the layer to be determined.

As elucidated in the foregoing, a clustering algorithm is then applied to group layers together having x, y, z spatial co-ordinates within a test volume as described earlier with reference to FIG. 3. Once such clustering has been applied, the layers of each cluster are analysed for their relative angular orientations which yields data recorded in the cluster and thus identity of the tag including the layers. When the identities of the tags in the region 50 have been identified, the data processor 100 is operable to output corresponding identification data through the external data bus 120 to the aforesaid external devices.

It will be appreciated that solving the simultaneous equations associated with Equation 4 is intensive on computing power provided by the data processor 100. In order to reduce processing requirements, software executing on the data processor 100 can be arranged to disregard signal peaks once their associated tags have been identified.

Such an elimination of identified signal peaks reduces computational requirements and hence renders the system 10 more responsive.

It will be appreciated that that the data processor 100 in operation at least one of:

(a) computes in real time to yield tag identification data; and

(b) stores the amplified pickup signals as samples in memory for subsequent off-line processing.

In the foregoing, it will also be appreciated that tags can be inserted into the interrogation region 50 in an abutting configuration so that there exists detection ambiguity despite application of the quasi-static magnetic field gradient to try to provide the data processor 100 with more data to discern. In order to address such ambiguity, the conveyor belt conveying items bearing the tags through the interrogation region 50 is preferably operable to redistribute the items spatially so that the tags are interrogated in a first spatial distribution in a first part of the region 50, and also interrogated in a second spatial distribution in a second part of the region 50. In order to redistribute the items spatially, the conveyor belt can for example include a partial obstruction which causes the items to tumble on the belt when transported from the first part to second part. Such tumbling assists to ensure that abutting tags in the first part are sufficiently mutually separated in the second part to reduce ambiguity when the data processor 100 performs its clustering algorithm.

With regard to abutting tags in the region 50, it will also be appreciated that visual inspection, for example using a camera connected to computer hardware performing image analysis, can be added to the system 10 as a confirmation that the data processor 100 has correctly read all the tags in the interrogation region 50. Although such visual inspection assists to reduce tag reading errors, such inspection is not however capable of identifying items which are visually occluded by the presence of other items.

It will be appreciated from the foregoing that orientation of the tag 60 is ambiguous in its 180° directions. Thus, the tag 60 is not capable of ensuring that its associated article is up-right or up-side down for example. Such ambiguity can be resolved by visual inspection. Alternatively, two tags similar to the tag 60 can be included on the article; if one of the tags is positioned on a top surface of the article and another is positioned on an underside surface of the system 10, the system 10 is capable from spatial positions of the two tags of unambiguously resolving whether or not the object is inverted.

It will be appreciated that modifications can be made to embodiments of invention described in the foregoing without departing from the scope of the invention.

For example, although the invention is described by way of embodiments based on magnetic tag technology, the invention is equally applicable to other types of tagging systems relying on alternative communication techniques. Such other types of systems include radio tagging systems, for example microwave tagging systems conforming to “Bluetooth” standards, and ultrasonic tagging systems.

1. A multiple tag interrogation system (10) for simultaneously interrogating a plurality of tags (200, 210, 220) each including at least two interrogatable features (600, 610, 620), the system (10) comprising a receiving region (50) for receiving the tags (200, 210, 220), interrogating means (100, 110, 150, 160, 170) for interrogating the tags (200, 210, 220) and processing means (40) to determine at least information carried by the said at least two interrogatable features (600, 610, 620) of each tag and spatial position characteristics of the said at least two interrogatable features (600, 610, 620) therein and to identify the information carried by individual tags (200, 210, 220) on the basis of the spatial characteristics of the interrogatable features (600, 610, 620).

2. A system according to claim 1, wherein the interrogating means (100, 110, 150, 160, 170) is operable to interrogate the tags (200, 210, 220) by using one or more of steered magnetic fields, ultrasonic radiation fields and electromagnetic radio radiation fields.

3. A system according to claim 1 or 2, wherein the interrogating means (100, 110, 150, 160, 170) includes transmitting means (110, 150) for directing an interrogating field towards the tags (200, 210, 220) and receiving means (160, 170, 100) for receiving a return field output from the tags in response to receiving the interrogating field thereat.

4. A system according to claim 3, wherein the receiving means (160; 400 to 450; 500, 510) is arranged to be substantially insensitive to the interrogating field directed towards the tags (200, 210, 220) and sensitive to the return field output from the tags (200, 210, 220).

5. A system according to claim 4, wherein the receiving means (160) comprises at least one sensor comprising a pair of transducers responsive to the interrogating field and to the return field, the transducers being arranged in opposition to render the pair substantially insensitive to the interrogating field and sensitive to the return field.

6. A system according to claim 3, 4 or 5, wherein the receiving means (160) includes a plurality of sensors (400 to 450) disposed around the receiving region (50), and the processing means (40) includes a processor (100) for processing signals generated from the sensors (400-450) in response to receiving the return field thereat, the processor (100) being operable to determine relative amplitude of the signals and thereby calculate spatial distribution of the interrogatable features (600, 610, 620) of tags (200, 210, 220) within the receiving region (50).

7. A system according to any preceding claim, wherein the interrogating means (110, 150, 160, 170) includes field modifying means for applying a quasi-static field gradient within the receiving region (50) for varying the amplitude of received signals in dependence on the position of the interrogatable features (600, 610, 620) in the receiving region (50).

8. A system according to any preceding claim, wherein the system (10) includes transporting means for conveying the tags (200, 210, 220) through the region (50).

9. A system according to claim 8, wherein the transporting means includes distributing means for spatially redistributing the tags (200, 210, 220) as they are transported through the region (50), the system being operable to interrogate the tags before and after the spatial redistribution.

10. A system according to claim 9, wherein the transporting means comprises a conveyor belt associated with region (50) for transporting the tags therethrough.

11. A system according to claim 10, wherein the system (10) includes controlling means (100) for transporting the tags in at least one of a continuous manner and stepwise manner through the region (50).

12. A system according to claim 3 or any claim directly or indirectly appendent thereto, wherein the transmitting means (150) includes one of more transducers (400 to 450) arranged to steer an interrogating field within the region for measuring angular orientation of the tags within the region (50).

13. A system according to claim 12, wherein the system includes means for measuring spatial position and angular orientation of features of the tags within the receiving region (50), the system further comprising computing means for grouping the features into clusters and thereby identifying from the clusters identity of the tags included within the region (50).

14. A system according to claim 13, wherein the computing means is arranged to discard data supplied from the interrogating means when performing computations corresponding to one or more tags which have already been identified in the region.

15. A system according to any preceding claim operable to interrogate magnetic tags.

16. A system according to claim 15, wherein the tags each include a plurality of features whose relative angular orientations are arranged to convey tag identification data, the system being operable to measure the relative angular orientations of the features and thereby identify the tags.

17. A system according to claim 15 or 16, wherein the return field from the tags is generated by the features in response to non-linear magnetic effects occurring therein when interrogated by the interrogating means.

18. A method for simultaneously interrogating a plurality of tags (200, 210, 220) each including at least two interrogatable features (600, 610, 620), the method comprising passing the tags through an interrogation region (50), interrogating the tags (200, 210, 220) in the interrogation region (50) determining from the interrogation information carried by the said at least two interrogatable features (600, 610, 620) of each tag, determining spatial position characteristics of the said at least two interrogatable features (600, 610, 620) and identifying the information carried by individual tags (200, 210, 220) on the basis of the spatial characteristics of the interrogatable features (600, 610, 620).

19. A method of as claimed in claim 18 including the steps of:
(a) receiving signals generated in the tags (200, 210, 220) in response to interrogation thereof;
(b) identifying spatial position and angular orientation of the features (600, 610, 620) of the tags (200, 210, 220);
(c) grouping the features (600, 610, 620) into clusters based upon their spatial positions and thereby determining corresponding tags (200, 210, 220) to which they belong; and
(d) determining from the angular orientation of the features (600, 610, 620) within each cluster data encoded into their associated tag (200, 210, 220), thereby identifying their associated tag (200, 210, 220).

20. A method according to claim 18, the method further comprising the step of associating characteristics in the signals with operating parameters of the system and spatial positions of the tags (200, 210, 220), and solving a plurality of simultaneous equations for calculating angular orientations of features included within the tags (200, 210, 220) and determining form the orientations data encoded on the tags (200, 210, 220).
